(19) United States
(12) Patent Application Publication
(10) Pub. No.: US 2026/0320561 A1
(43) Pub. Date: Oct. 15, 2026

(54) METHOD FOR REUSING SCHEDULE INFORMATION

(71) Applicant: C.G.TAE TECHNOLOGY INC., Seongnam-si, Gyeonggi-do (KR)

(72) Inventors: Chul Gyu TAE, Seongnam-si, Gyeonggi-do (KR); Choe TAE, Seongnam-si, Gyeonggi-do (KR)

(21) Appl. No.: 19/101,336

(22) PCT Filed: Aug. 4, 2023
(86) PCT No.: PCT/KR2023/011453

§ 371 Date: Jul. 15, 2025

(30) Foreign Application Priority Data
Aug. 5, 2022 (KR) 10-2022-0097783

(51) Int. Cl. G06Q 10/109; G06F 3/0482; G06F 3/0484

(52) U.S. Cl. CPC G06Q 10/109; G06F 3/0482; G06F 3/0484

(57) ABSTRACT

A method for reusing schedule information, comprises displaying one or more schedule items including time information and other schedule information for a schedule in the user interface of an application, wherein the user interface includes a reuse button associated with each of the schedule items, receiving a selection of the reuse button associated with a schedule item, and in response to receiving the selection of the reuse button, filling other schedule information corresponding to the schedule item in an input panel of the user interface, wherein the input panel includes a first item display section, and the filling includes, in response to receiving the selection of the reuse button, filling at least one item button of the first associated category corresponding to the schedule item in the first item display section.

### TECHNICAL FIELD

The present disclosure relates to a method for reusing schedule information, and more specifically, to a method that enables efficient schedule input with minimal content by using a reusing button when a user inputs a schedule through a calendar application.

### BACKGROUND ART

The use of calendar applications on various user devices, such as personal computers (PCs), laptops, tablets, mobile phones, and wearable devices, has become widespread. These calendar applications initially only had functions, such as simply displaying a calendar and allowing users to input simple schedules. However, they have gradually evolved to include various features that enhance the user experience. However, the majority of users of conventional calendar applications often do not fully utilize or are unable to utilize most of the various features offered. In most cases, they use calendar applications merely for sporadically recording a few schedules and setting reminders.

### SUMMARY OF INVENTION

### Technical Problem

Accordingly, an object of the present disclosure is to provide a schedule input method that may enhance the user's utilization of the calendar application. More specifically, the present disclosure aims to allow each schedule item to be promptly and easily registered using existing schedule items, and also to enable each schedule item to be swiftly and easily edited or deleted, thereby allowing users of the calendar application to conveniently and systematically recognize and manage their schedules.

However, the problems to be solved by the present disclosure are not limited to those mentioned above. The objects not explicitly mentioned but clearly understood by those skilled in the art to which the present disclosure pertains, based on the following description, are also included within the scope of the present disclosure.

### Solution to Problem

According to some aspects of the disclosure, a method for reusing schedule information, comprises: displaying one or more schedule items including time information and other schedule information for a schedule in the user interface of an application, wherein the user interface includes a reuse button associated with each of the schedule items, receiving a selection of the reuse button associated with a schedule item among the one or more schedule items, and in response to the receiving the selection of the reuse button, filling other schedule information corresponding to the schedule item associated with the reuse button in an input panel of the user interface, wherein the input panel includes a first item display section, and in response to the receiving the selection of the reuse button, the filling other schedule information corresponding to the schedule item associated with the reuse button in the input panel of the user interface includes: in response to the receiving the selection of the reuse button, filling at least one item button of the first associated category corresponding to the schedule item in the first item display section.

According to some aspects, the method further comprises: receiving time input for the other schedule information filled in the input panel, and creating a new schedule item corresponding to the other schedule information and the time input.

According to some aspects, the other schedule information includes category information for two or more categories of the schedule.

According to some aspects, the other schedule information further includes at least one of information about another user associated with the schedule and the attachments associated with the schedule.

According to some aspects, the one or more schedule items are displayed in a schedule display table displayed on the user interface.

According to some aspects, the one or more schedule items are displayed in a timeline displayed on the user interface.

According to some aspects, the user interface further includes an edit button in addition to the reuse button, and the method further comprises: receiving a selection of the edit button associated with a schedule item among the one or more schedule items, and in response to the receiving the selection of the edit button, filling time information and other schedule information corresponding to the schedule item in the input panel of the user interface.

According to some aspects, the method further comprises: receiving a selection of a schedule item among the one or more schedule items, and in response to the receiving the selection of the schedule item, filling time information and other schedule information corresponding to the schedule item in the input panel of the user interface.

According to some aspects, the input panel further includes a second item display section, and in response to the receiving the selection of the reuse button, the filling other schedule information corresponding to the schedule item associated with the reuse button in the input panel of the user interface further includes: in response to the receiving the selection of the reuse button, filling at least one item button of the second associated category corresponding to the schedule item, wherein the second associated category is a category associated with the first associated category, into the second item display section.

According to some aspects, the method further comprising: receiving time input for the other schedule information filled in the input panel; and creating a new schedule item corresponding to the other schedule information and the time input, wherein the newly created schedule item is further associated with one or more upper categories for the first associated category.

According to some aspects of the disclosure, an apparatus for executing an application for implementing a method for reusing schedule information, the apparatus comprises: a processor, and a memory including computer-executable instructions, wherein the computer-executable instructions, when executed by the processor, cause the processor to perform operations including: displaying one or more schedule items, including time information and other schedule information for a schedule, in a user interface of the application, wherein the user interface includes a reuse button associated with each schedule item, receiving a selection of the reuse button associated with a schedule item among the one or more schedule items, and in response to the receiving the selection of the reuse button, filling other schedule information corresponding to the schedule item associated with the reuse button in the input panel of the user interface, and wherein the input panel includes a first item display section; and
in response to the receiving the selection of the reuse button, the filling the other schedule information corresponding to the schedule item associated with the reuse button in the input panel of the user interface includes: in response to the receiving the selection of the reuse button, filling at least one item button of the first associated category corresponding to the schedule item in the first item display section.

According to some aspects of the disclosure, a computer-readable recording medium storing computer-executable instructions, wherein the computer-executable instructions, when executed by a processor, cause the processor to perform operations including: displaying one or more schedule items, including time information and other schedule information for a schedule, in a user interface of the application, wherein the user interface includes a reuse button associated with each schedule item; receiving a selection of the reuse button associated with a schedule item among the one or more schedule items; and in response to the receiving the selection of the reuse button, filling other schedule information corresponding to the schedule item associated with the reuse button in an input panel of the user interface, and wherein the input panel includes a first item display section; and in response to the receiving the selection of the reuse button, the operation of the filling other schedule information corresponding to the schedule item associated with the reuse button in the input panel of the user interface further includes: in response to the receiving the selection of the reuse button, filling at least one item button of the first associated category corresponding to the schedule item in the first item display section.

### Advantageous Effects

According to the embodiments of the present disclosure, a schedule input method that enhances the user's utilization of a calendar application may be provided. More specifically, the present disclosure aims to allow each schedule item to be promptly and easily registered using existing schedule items, and also to enable each schedule item to be swiftly and easily edited or deleted, thereby allowing users of the calendar application to conveniently and systematically recognize and manage their schedules.

Furthermore, such systematic and convenient schedule management may ultimately improve the user's work efficiency and serve as a motivation for the user to actively utilize schedule management through the calendar application.

However, the effects achievable by the present disclosure are not limited to those mentioned above. Other effects not explicitly mentioned may also be clearly understood by those skilled in the art to which the present disclosure pertains based on the following description.

### BRIEF DESCRIPTION OF THE DRAWINGS

The following drawings attached to the present specification illustrate preferred embodiments of the present disclosure and serve to further aid in understanding the technical spirit of the present disclosure in conjunction with the detailed description. Therefore, the present disclosure should not be construed as being limited only to the matters described in such drawings.

FIGS. 1a and 1b are diagrams illustrating examples of a system for using a calendar application according to an embodiment of the present disclosure.

FIG. 2 is an exemplary diagram illustrating the main screen of the user interface for the calendar application according to an embodiment of the present disclosure.

FIGS. 3 and 4 are exemplary screens illustrating the main window of the user interface for the calendar application according to an embodiment of the present disclosure when scrolled upward and downward, respectively.

FIGS. 5a and 5b are exemplary diagrams illustrating the basic form and the expanded form of the timeline for dates other than today in the user interface of the calendar application according to an embodiment of the present disclosure.

FIG. 6a is a diagram illustrating the input panel 220 according to an embodiment of the present disclosure and FIG. 6b is a diagram illustrating an additional usage example of the input panel according to an embodiment of the present disclosure.

FIG. 7a, FIG. 7b, FIG. 7c, and FIG. 7d are diagrams illustratively describing the method for inputting schedules through the input panel of the calendar application according to an embodiment of the present disclosure.

FIG. 8 is a diagram illustrating the schedule display table in the user interface of the calendar application according to an embodiment of the present disclosure.

FIG. 9 is a flowchart illustrating the method for inputting schedules using the reuse button according to an embodiment of the present disclosure.

FIGS. 10 and 11 are exemplary diagrams illustrating the method for adding schedules using the reuse button of a schedule item in the schedule display table according to an embodiment of the present disclosure.

FIG. 12 is an exemplary diagram illustrating a method for adding a schedule using an edit button of the schedule items according to an embodiment of the present disclosure.

FIG. 13 is an exemplary diagram illustrating a method for adding a schedule using the reuse button of a schedule box in the timeline according to another embodiment of the present disclosure.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

In addition, the same reference numerals are used throughout the drawings to refer to elements having similar functions and operations. Throughout the specification, when a particular element is described as being connected to, above, or below another element, such descriptions include both direct and indirect connections or positional relationships, with or without intervening elements.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Although terms such as first, second used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

### System for Using a Calendar Application

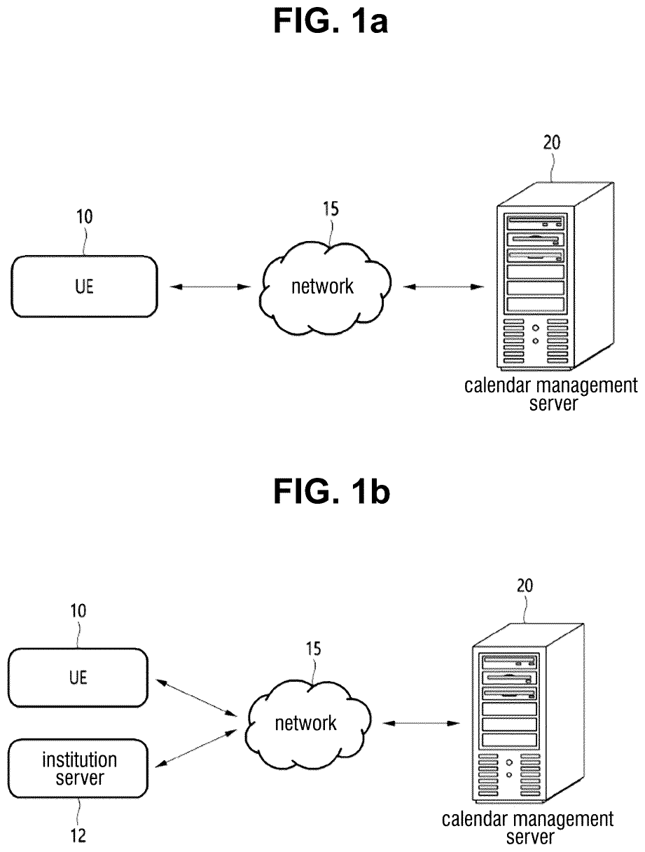

FIGS. 1a and 1b are diagrams illustrating examples of a system for using a calendar application according to an embodiment of the present disclosure.

Referring to the system shown in FIG. 1a, a user device 10 may be connected to a calendar management server 20 via a network 15. According to embodiments of the present disclosure, the calendar application may be installed on the user device 10 or may be used by utilizing calendar application-related resources of the calendar management server 20 in the form of a cloud through the user device 10. Additionally, the calendar application may be distributed across the user device 10 and the calendar management server 20.

A calendar application according to an embodiment of the present disclosure is an application for inputting and managing schedules, and may encompass not only a dedicated calendar application but also any application that includes a calendar function or a function similar to a calendar.

The user device 10 may be any device equipped with a display capable of displaying the calendar application, such as a personal computer (PC), laptop, tablet, mobile phone, or wearable device, and may connect to the calendar management server via a network. The same user may use two or more user devices. In this case, the calendar application may operate in synchronization across the user's devices, or it may operate on only one user device at a time. The present disclosure does not limit the implementation method in this regard.

The network 15 may be a wired or wireless network. The user device 10 may connect to the network 15 through a wired LAN cable, through wireless internet such as Wi-Fi, 3G/4G/5G data networks at locations equipped with wireless access points (APs), or by transmitting and receiving wireless signals with peripheral devices to connect to the network 15. The specific method of connection is not limited.

The calendar management server 20 may be a server for providing, servicing, and managing the calendar application. As an example, the calendar management server 20 may provide services and updates for the calendar application, collect various data related to the calendar application, and generate and provide statistical information. The calendar management server 20 may provide the calendar application in the form of a cloud service or deliver calendar-related services through communication with the calendar application installed on the user device 10. The specific operational methods are not limited.

Referring to the system shown in FIG. 1b, the user device 10 and the institution server 12 may be connected to a calendar management server 20 via a network 15. The institution server 12, for example, may be a server operated by various institutions such as companies, schools, public institutions, or research institutes, and the user device 10 may be a personal device belonging to an individual affiliated with such an institution. In this case, the user device 10 may use the calendar application provided through the institution server 12 or, similar to the example in FIG. 1a, use the calendar application installed on the user device 10 itself or by utilizing the resources of the calendar management server 20.

However, unlike the examples in FIGS. 1a and 1b, the calendar application may be used solely on the user device, or it may operate in the form of an intranet only between the institution server and the user device without being connected to the calendar management server 20. The specific implementation methods are not limited.

In the example of the system in FIG. 1a and the example of the system in FIG. 1b, the user device 10 connects to the calendar management server 20 via the network 15, and the schedule data generated by the user utilizing the calendar application on the user device 10 may be collected by at least one of the calendar management server 20 or the institution server 12. For such schedule data to be collected and meaningful statistical data to be generated, the utilization of the calendar application must be enhanced. To achieve this, users need to be provided with motivation to actively use the calendar application. The calendar application and its user interface according to an embodiment of the present disclosure include various elements that enable users to gain positive experiences, such as improved work efficiency and prompt work feedback, through the use of the calendar application. These elements will be described in detail later. Meanwhile, in this regards, there may be issues related to privacy concerns, however, the present disclosure focuses solely on the technical aspects, irrespective of such issues.

### Configuration of the Main Screen of the User Interface For the Calendar Application

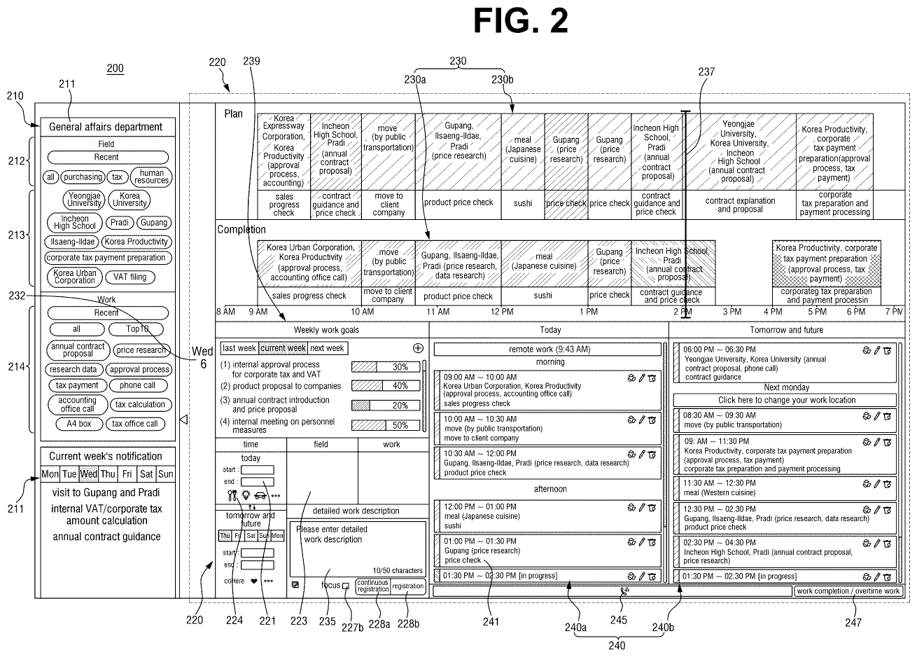

FIG. 2 is an exemplary diagram illustrating the main screen of the user interface for the calendar application according to an embodiment of the present disclosure.

In the user interface of the calendar application according to an embodiment of the present disclosure, the term “main screen” refers to the screen presented to the user upon first logging into the calendar application. However, the term “main screen” is used merely for convenience of explanation, and the user may customize the initial screen settings of the calendar application, the configuration may vary depending on the display size of the user device, or the layout of the initial screen may change according to updates to the calendar application. Therefore, the configuration of the main screen described below is merely exemplary.

Additionally, for convenience of explanation, this specification describes “a first time range” as referring to today, “a second time range” as referring to tomorrow and the future (dates after tomorrow), and “a third time range” as referring to the past (yesterday and dates before yesterday). However, the first to third time ranges may each be defined as different time ranges, and they are not limited thereto.

Referring to FIG. 2, the main screen 200 of the user interface for the calendar application may include: a category selection window 210 that allows for the selection and input of one or more categories of schedules; an input panel 220 for entering the time, category, and detailed work description for schedules of today (i.e., the first time range) or tomorrow and the future (i.e., the second time range); a timeline 230 that includes a planned timeline and a completed timeline, which respectively display in chronological order the planned schedules the user intends to carry out today and the completed schedules actually carried out; and a schedule display table 240 that displays the schedules for today and for tomorrow and the future in the form of separate tables.

First, the category selection window 210 allows the user to select and input one or more categories related to the schedule, such as four categories. Among these four categories, the first category 211 may be the highest-level category, and for example, could be the “Department” category. The second category 212 may be the next-level category, which, for example, may classify “Fields” or “Teams.” The third category 213 may be a lower category of the second category 212 and may classify “Projects,” while the fourth category 214 may be a lower category of the third category 213 and may classify “Works.” However, the detailed configuration of each category in the category selection window 210 may be changed by user selection or other factors, and this is not intended to be limiting.

At least some of the first to fourth categories 211, 212, 213, and 214 in the category selection window 210 may be selected by default, considering schedules recently performed by the user, all schedules, and so on. This is designed to minimize the need for the user to input all four categories individually. As a result, by introducing the category selection window 210 according to an embodiment of the present disclosure, an effect is achieved in which the user can input categories with minimal input without feeling burdened.

The input panel 220 is an interface that allows the user to input time, category, and detailed work description for schedules for today (i.e., the first time range) or tomorrow and the future (i.e., the second time range). The schedules entered through the input panel 220 may either be newly registered schedules that will be created in the timeline 230 and the schedule display table 240, or schedules selected for editing from among those already displayed in the timeline 230 and the schedule display table 240. The specific usage method of the input panel 220 will be described in detail later.

The timeline 230 may include a completed timeline 230a that displays schedule boxes 231a for one or more completed schedules of the user for today in chronological order from left to right, and a planned timeline 230b that displays schedule boxes 231b for one or more planned schedules of the user for today in chronological order from left to right. Each schedule box 231a or 231b may be input and created by the user through the input panel 220.

The schedule display table 240 may include a first schedule display table 240a for displaying today's schedules in chronological order from top to bottom, and a second schedule display table 240b for displaying tomorrow's and future schedules in chronological order from top to bottom. The first schedule display table 240a and the second schedule display table 240b each include one or more schedule items 241, and each schedule item 241 may be input and created by the user through the input panel 220.

Additionally, the main screen 200 may further include: a goal display section 239 for graphically displaying the progress of work goals; a call history check button 245 that allows the user to save and view key call records; a work completion button 247 that enables the user to select between leaving work or working overtime; and a date display section 232 that displays schedule-related dates, work locations, and other schedule-related information. Additionally, below the category selection window 210, there may be a weekly notification display section 211 that provides information on the planned schedules for the current week and a personal notepad (not shown).

As seen in the example of FIG. 2, the main screen 200 may include a category selection window 210 located in the left area of the main screen 200 and a main window 215 located to the right of the category selection window 210. Additionally, the timeline 230 may be located in the upper area of the main window 215, with the goal display section 239 and the input panel 220 positioned in the lower left section of the timeline 230, and the schedule display table 240 positioned in the center and lower right section of the timeline 230.

In the user interface of the calendar application according to an embodiment of the present disclosure, by placing the category selection window 210, which allows for schedule input, in the left section of the main screen 200, and the input panel 220 in the lower central section, the user is enabled to perform schedule input intuitively and easily. Additionally, by arranging schedules in two formats, namely a timeline and a table, respectively in the upper section and the lower right section of the main screen 200, the user is enabled to intuitively and easily check and manage their schedules.

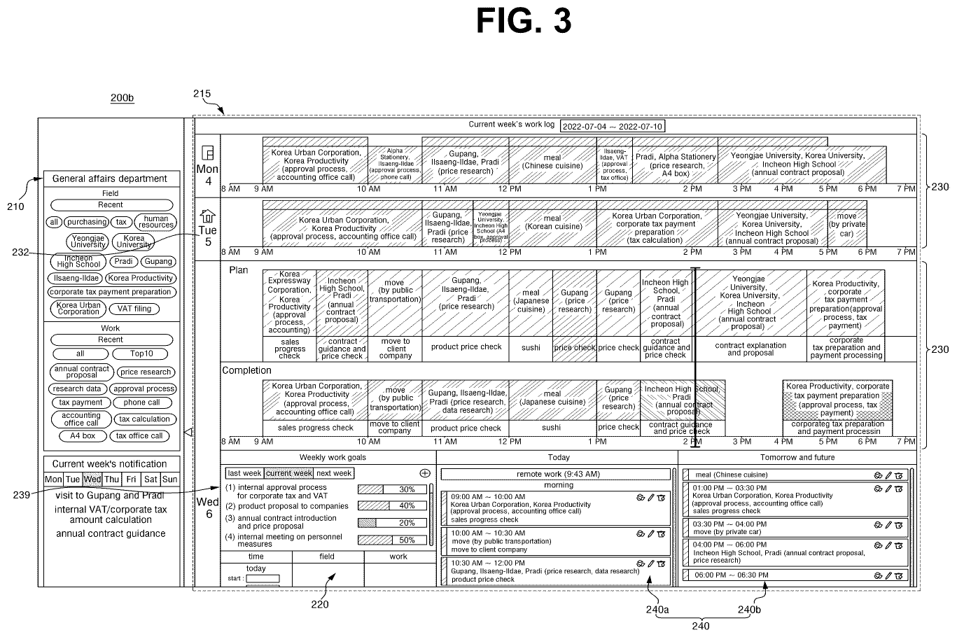

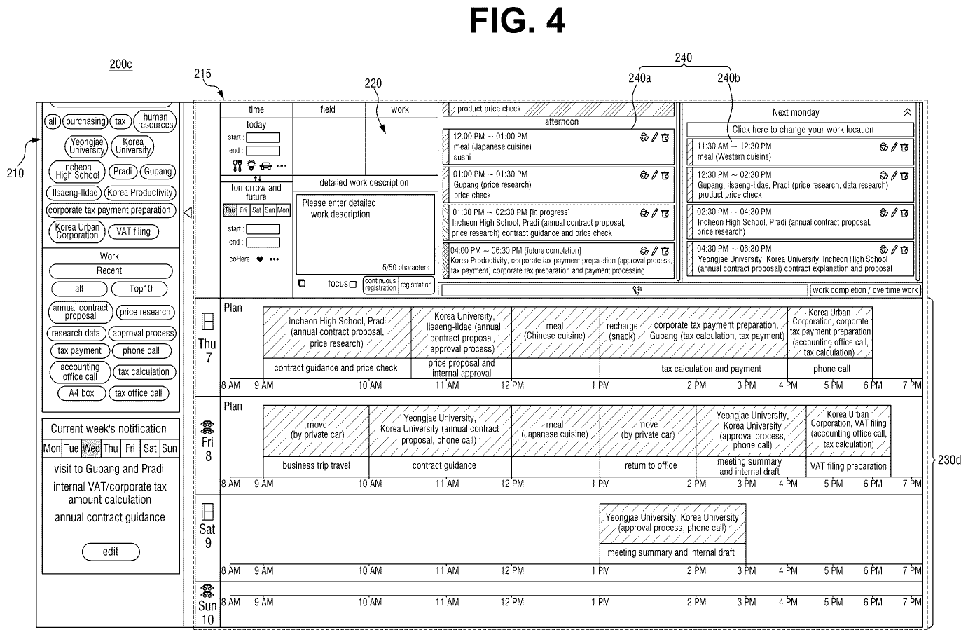

FIGS. 3 and 4 are exemplary screens illustrating the main window of the user interface for the calendar application according to an embodiment of the present disclosure when scrolled upward and downward, respectively. Referring to FIGS. 3 and 4, the main window 215 of the user interface for the calendar application according to an embodiment of the present disclosure is scrollable in the vertical direction.

First, referring to FIG. 3, in an exemplary screen 200b where the main window 215 is scrolled upward by manipulating the scrollbar or similar elements on the right side of the main window 215, one or more past timelines 230c, which display the schedules of yesterday (e.g., Tuesday) and the day before yesterday (e.g., Monday) in chronological order, may be displayed on the timeline 230 that chronologically shows today's (e.g., Wednesday's) schedules.

According to an embodiment of the present disclosure, the date range for the current week (e.g., “Current Week's Work Log 2002-07-04~2022-07-10”) is displayed at the top of the main window 215, and only the timelines for the displayed current week, i.e., the schedule for a one-week period (Monday to Sunday of the week), may be viewed by scrolling. In the example of FIG. 3, today is Wednesday, and the past timeline 230c is shown to include two timelines corresponding to Tuesday and Monday. However, the number of past timelines 230c may vary depending on which day of the week today is.

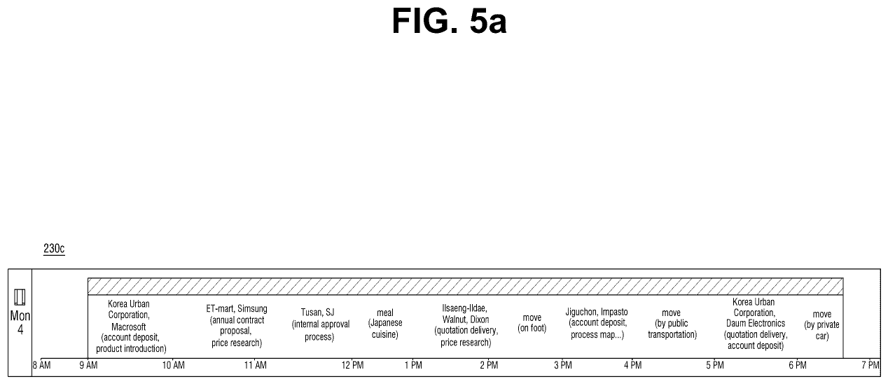

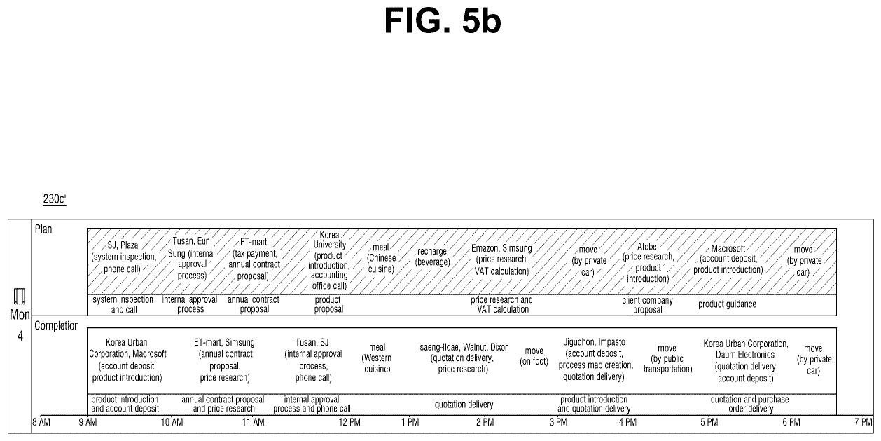

According to an embodiment, the past timeline 230c pertains to schedules prior to today (past) and may include both the timelines for planned schedules the user had set in the past and the timelines for completed schedules the user actually performed. For efficient use of display space, the planned schedules and completed schedules may each be displayed in a collapsed form. This will be described in detail later with reference to FIG. 5.

Referring to FIG. 4, in an exemplary screen 200c where the main window 215 is scrolled downward by manipulating the scrollbar or similar elements on the right side of the main window 215, one or more future timelines 230d, which display the schedules for tomorrow and the future in chronological order by date, may be displayed below the input panel 220 and the schedule display table 240. In the example of FIG. 4, since today is Wednesday, four future timelines 230d corresponding to Thursday through Sunday of the current week are displayed. Since the future timeline 230d pertains to the future, it does not include completed schedules and may only contain planned schedules.

FIGS. 5a and 5b are exemplary diagrams illustrating the basic form and the expanded form of the timeline for dates other than today in the user interface of the calendar application according to an embodiment of the present disclosure.

Referring to FIG. 5a, the past timeline 230c for dates prior to today, in the basic (default) form, may display the planned schedules in a thin format where only the time slots of the schedules are visible, while the completed schedules may be displayed in a state where only the category information of the schedules is visible, with the detailed work descriptions omitted. Overall, it may take the form where the simplified timeline for planned schedules is displayed in a thin format on the simplified timeline for completed schedules, and in this case, the planned schedules and completed schedules may be distinguished by different colors. Displaying the past timeline 230c in a simplified form (i.e., the basic form) is intended to efficiently utilize the display space of the main screen and the main window and to allow users to promptly recognize the details of the week's schedules and whether planned schedules have been established.

Referring to FIG. 5b, when the user selects or hovers over any position on the past timeline 230c using an input such as a mouse or touch, the past timeline 230c may transform into an expanded timeline 230c′. In the case of the expanded past timeline 230c′, similar to the timeline 230 for today's date (refer to FIGS. 2 and 3), it may include two timelines: a planned timeline for planned schedules and a completed timeline for completed schedules. The planned schedules and completed schedules may be displayed chronologically, allowing users to view both the category information and detailed schedule information for each schedule.

### Method for Inputting Schedules Through the Input Panel

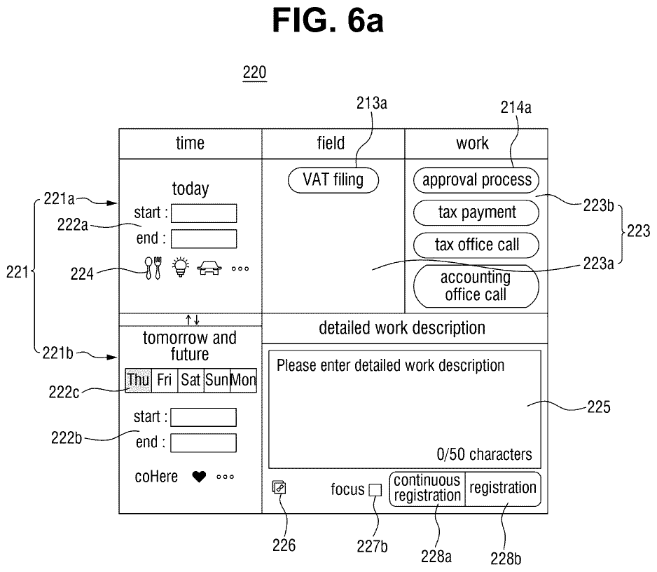

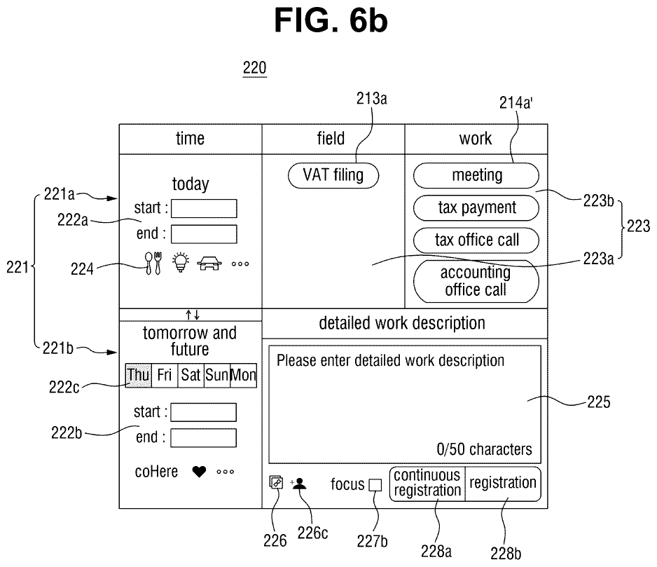

FIG. 6a is a diagram illustrating the input panel 220 according to an embodiment of the present disclosure.

Referring to FIG. 6a, the input panel 220 may include a time input section 221 for entering the time for a schedule; and an item display section 223, which displays item buttons for categories already selected by the user for the schedule and/or one or more item buttons recommended for the categories by the calendar application, allowing the user to make selections.

Additionally, the input panel 220 according to an embodiment of the present disclosure may include multiple quick buttons 224 for promptly adding repetitive or routine schedules such as meals, recharge (rest), or move; a detailed description input section 225 for entering detailed work information for the schedule; a link creation button 226 for adding attachments or links related to the schedule; an external work button (not shown) for indicating that the schedule is an off-site activity; a focus button 227b for indicating that the schedule requires concentration; a registration button 228b for registering the created schedule; and a consecutive registration button 228a for registering sequential schedules.

For example, the consecutive registration button 228a is a button that, when adding sequential schedules, sets the start time in the time input section 221 to the end time of the previously added schedule after adding a specific schedule, thereby enabling the user to promptly input consecutive schedules. For example, after entering a schedule for 9:00 AM to 9:30 AM and selecting the consecutive registration button 228 a, a schedule item for 9:00 AM to 9:30 AM is created, while the time input section 221 automatically updates to 9:30 AM to 10:00 AM, allowing the user to conveniently input the subsequent schedule.

The time input section 221 of the input panel 220 according to an embodiment may include a first time input section 221a and a second time input section 221b. The first time input section 221a is for inputting schedules within the first time range, for example, today's schedules, and may include a first time input box 222a that allows the user to input the start time and end time for today's schedule. Additionally, the second time input section 221b is for inputting schedules within the second time range, which follows the first time range, for example, schedules for tomorrow and the future, and it may be positioned below the first time input section 221a. The second time input section 221b may include a second time input box 222b that allows the user to input the start time and end time for the schedules of each date (day of the week) within the second time range. Additionally, the second time input section 221b may include a day-of-the-week selection section 222c that displays the dates for tomorrow and the following days as days of the week. As in the example of FIG. 4, if today is Wednesday, the five days displayed in the day-of-the-week selection section 222c may be Thursday (Thu), Friday (Fri), Saturday (Sat), Sunday (Sun), and Monday (Mon).

According to another embodiment, the time input section 2210 of the input panel 220 may be implemented with a single time input section instead of being composed of two separate time input sections. In this case, a single time input section may include both a time input box and a day-of-the-week selection section. However, the specific form of the input panel is not limited.

The input panel 220 may include an item display section 223 that displays the item buttons of categories selected by the user for the schedule or the recommended category item buttons suggested by the calendar application for the schedule, enabling the reception of user selection for categories

The item display section 223 may include a first item display section 223a and a second item display section 223b. More specifically, the first item display section 223a may display one or more item buttons selected by the user from the item buttons 213a of the third category 213 of the category selection window 210 shown in FIG. 2, or up to a predetermined number (e.g., up to 5) of item buttons recommended by the calendar application. Additionally, the second item display section 223b may display one or more item buttons selected by the user from the item buttons 214a of the fourth category 214 in the category selection window 210, or up to a predetermined number (e.g., up to 5) of recommended item buttons suggested by the calendar application.

In a non-limiting example, the recommendation of one or more item buttons in each of the first item display section 223a and the second item display section 223b may be based on the usage frequency of each item button. In another example, the calendar application may recommend item buttons by comprehensively considering factors such as the usage frequency, time, cycle, ongoing works, and projects of each item button within the categories through an artificial neural network module.

FIG. 6b is a diagram illustrating an additional usage example of the input panel according to an embodiment of the present disclosure. Referring to FIG. 6a, when an item button 214a′ corresponding to a work requiring communication with other users, such as “Meeting,” is selected from the item buttons in the fourth category 214, a person icon 226c for adding other users may be added to a certain area of the input panel 220. If the user selects the person icon 226c, a user interface allowing the addition of other users who attended or are scheduled to attend the meeting may be displayed. Through this user interface, the user may add other users associated with the meeting, and the added users may be viewable through the schedule boxes 231a and 231b on the timeline 230 or the schedule items 241 in the schedule display table 240.

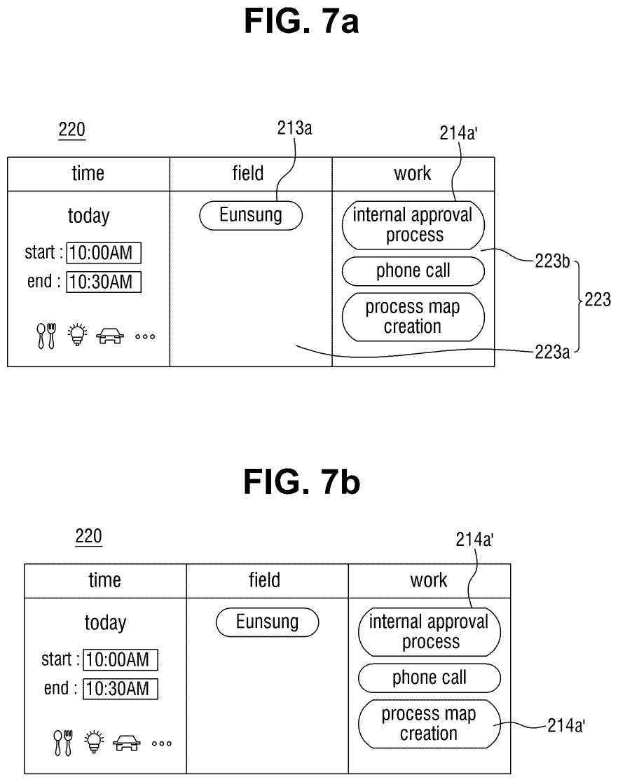

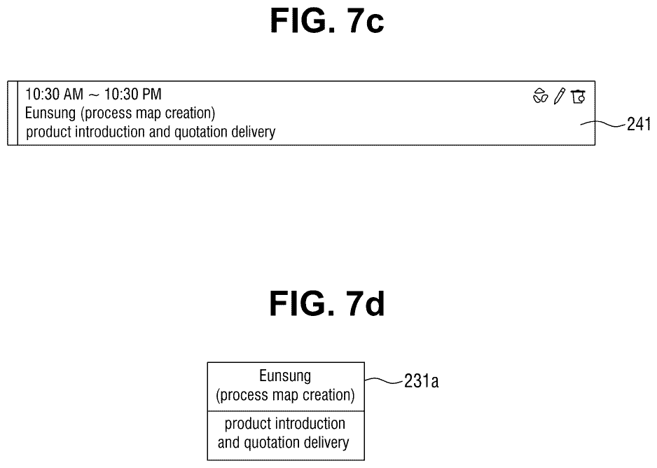

FIG. 7a, FIG. 7b, FIG. 7c, and FIG. 7d are diagrams illustratively describing the method for inputting schedules through the input panel of the calendar application according to an embodiment of the present disclosure.

Referring to FIG. 7a, the first item display section 223a of the input panel 220 of the calendar application may display one or more item buttons 213a for the category of the schedule. Additionally, in the second item display section 223b of the input panel 220, one or more item buttons 214a of the lower category associated with one or more item buttons 213a displayed in the first item display section 223a may be displayed.

According to an embodiment, one or more item buttons 213a displayed in the first item display section 223a may correspond to one or more item buttons within the third category 213 (see FIG. 2), and one or more item buttons 214a displayed in the second item display section 223b may correspond to one or more item buttons within the fourth category 214 (see FIG. 2).

According to an embodiment, one or more item buttons 213a displayed in the first item display section 223a may be item buttons 213a selected by the user through the category selection window 210 shown in FIG. 2. In such a case, the calendar application may display a predetermined number (e.g., up to 5) of item buttons 214a with high usage frequency among one or more item buttons 213a of the fourth category associated with one or more item buttons 213a of the third category as recommended item buttons on the second item display section 223b.

However, in the case where the user does not select an item button from the third category through the category selection window 210, the calendar application may recommend item buttons from the third category based on usage frequency or other factors and display them in the first item display section 223a. Alternatively, in the first item display section 223a, item buttons that were recently used within the third category or all item buttons from the third category may be displayed by default.

As a non-limiting example, in the case of FIG. 7a, an item button from the third category (project) labeled “EunSung,” selected by the user through the category selection window 210, may be displayed in the first item display section 223a of the input panel 220. Additionally, the user may input a time range, such as 10:00 AM to 10:30 AM, in the time input section.

Next, referring to FIG. 7b, the user may select one or more item buttons 214a′ (e.g., “Process Map Creation”) from the recommended item buttons 214a displayed in the second item display section 223b of the input panel 220, which belong to the fourth category (a lower category of the third category), such as item buttons for “Internal Approval Progress,” “Phone Call,” and “Process Map Creation.”

Additionally, the user may input schedule-related details (e.g., “Product Introduction and Quotation Delivery”) in the detailed description input section 225, and then register (or modify) the schedule by selecting the registration button 228b or the continuous registration button 228a shown in FIG. 6.

However, the above example describes the case where only one item button is selected, but it is possible to select two or more item buttons simultaneously from the item buttons displayed in the first and second item display sections 223a and 223b, respectively. Additionally, it is not necessary for content to be entered in the detailed description input section 225 when registering the schedule.

FIGS. 7c and 7d illustrate examples of schedule items 241 in the schedule display table 240 and schedule boxes 231a on the timeline 230, respectively, which were created through the process exemplified in FIGS. 7a and 7b.

As shown in FIG. 7c, the schedule item 241 in the schedule display table 240 may include the schedule's time, category information (i.e., information on the item buttons of each of the third category and the fourth category), and detailed schedule-related descriptions.

Additionally, as shown in 7d, the schedule box 231 a on the timeline 230 may also include the schedule's category information (i.e., information on the item buttons of each of the third category and the fourth category) and detailed schedule-related descriptions.

### Configuration of the Schedule Display Table

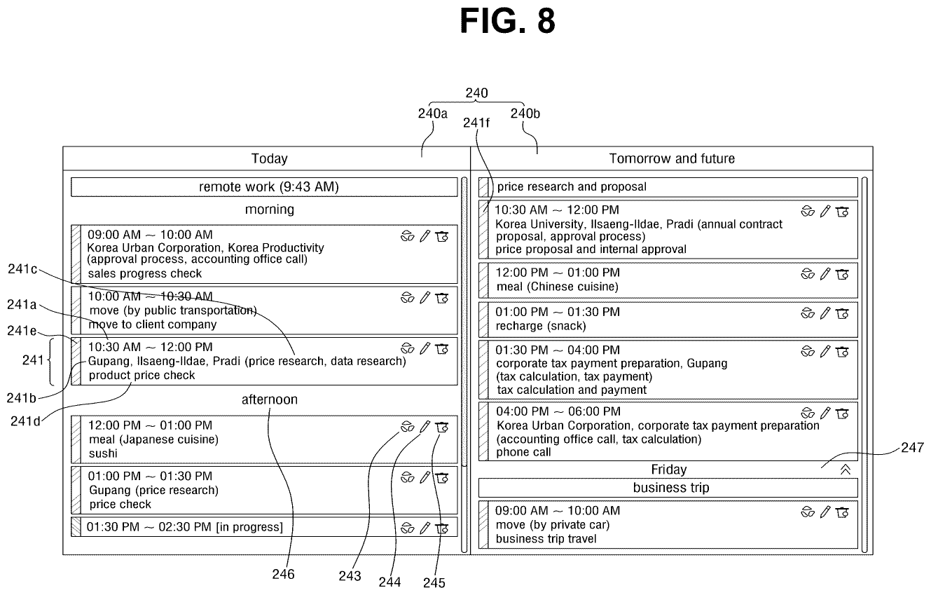

FIG. 8 is a diagram illustrating the schedule display table in the user interface of the calendar application according to an embodiment of the present disclosure.

Referring to FIG. 8, the schedule display table 240 may include a first schedule display table 240a for displaying today's schedules in chronological order from top to bottom, and a second schedule display table 240b for displaying tomorrow's and future schedules in chronological order from top to bottom. The first schedule display table 240a and the second schedule display table 240b each include one or more schedule items 241, which, as previously described, may be generated and registered by the user through the input panel 220.

Unlike conventional calendar applications, which typically display only schedule title and time for each schedule item, the schedule item 241 according to an embodiment of the present disclosure may include information such as the start and end times of the schedule 241a, the third category of the schedule 241b (e.g., project), the fourth category of the schedule 241c (e.g., work), and the detailed description of the schedule 241d.

In a non-limiting example, among the schedule items in the first schedule display table 240a, the schedule items prior to the current time may correspond to completed schedules already performed by the user. Completed schedule items may include an identifier (e.g., a label, flag, etc.) 241e in a first color (e.g., blue) in the left area of the schedule item 241.

Among the schedule items in the first schedule display table 240a, schedule items currently in progress at the current time may include an identifier in a third color (e.g., green) in the left area of the schedule item.

Additionally, among the schedule items in the first schedule display table 240a, the schedule items for schedules after the current time may be planned schedule items for planned schedules that the user is scheduled to perform in the future. Such planned schedule items may include an identifier 241f in a second color (e.g., purple) that is different from the first color or the third color, in the left area of the schedule item 241.

On the other hand, when the time range corresponding to a planned schedule item has passed, the planned schedule item may be removed from the first schedule display table 240a. This is because the planned schedule item, whose time range has passed, no longer falls under the category of planned schedules. By removing planned schedule items as time passes, it is possible to prevent a situation where multiple schedule items corresponding to overlapping time ranges are mixed together in the first schedule display table 240a.

The schedule items in the second schedule display table 240b pertain to schedules for tomorrow and the future (i.e., the second time range) and may therefore correspond to planned schedules that the user is scheduled to perform in the future. These schedule items in the second schedule display table 240b may also include an identifier 241f in a second color (e.g., purple), different from the first color, on the left side of the schedule item. However, the identifiers 241e and 241f may be distinguished by methods other than color, such as using icons or other means, and are not limited thereto. Planned schedule items for tomorrow and the future may receive day selection through the day selection section 222c of the input panel 220 shown in FIG. 6, and receive time input through the second time input section 222b.

Additionally, the first schedule display table 240a may include a “Work Information Identifier” indicating the work start time and location, a “Morning Identifier” representing the morning, and an “Afternoon Identifier” 246 distinguishing between the morning and the afternoon, placed between the schedule items. Additionally, the second schedule display table 240b may include identifiers 247 for the days-of-the week of tomorrow or subsequent days placed between the schedule items.

Furthermore, each schedule item 241 in the schedule display table 240 according to an embodiment of the present disclosure may include a reuse button 243, an edit button 244, and a delete button 245 in the top-right corner.

Among these, the delete button 245 may be used to delete the corresponding schedule item 241 to which the delete button 245 belongs. The usage of the reuse button 243 and the edit button 244 will be described in detail below.

### Method for Inputting Schedules Using the Reuse Button

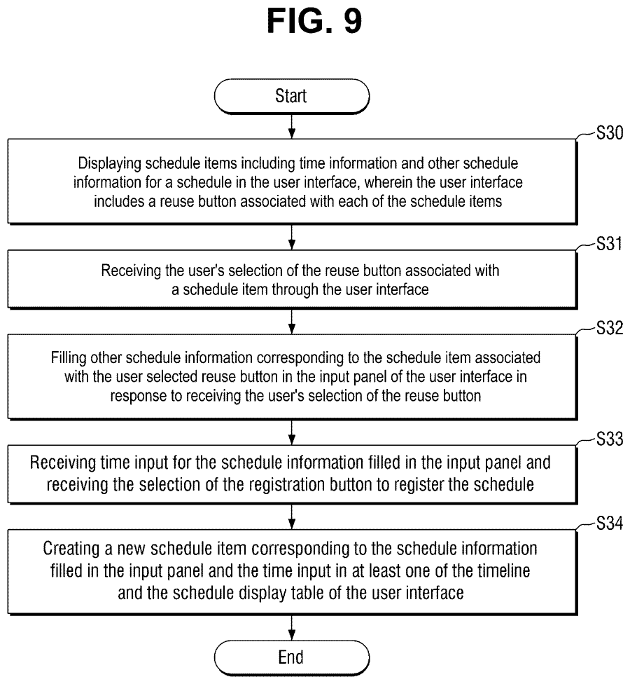

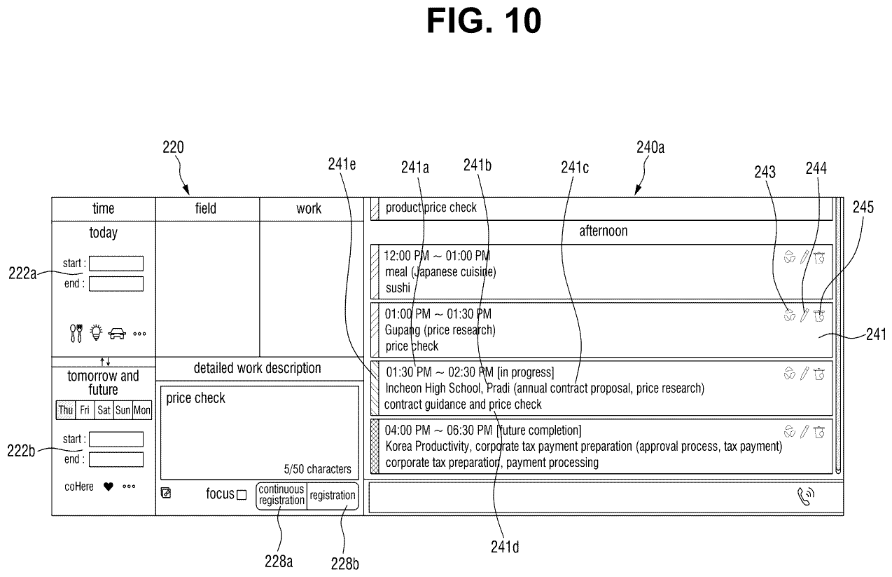

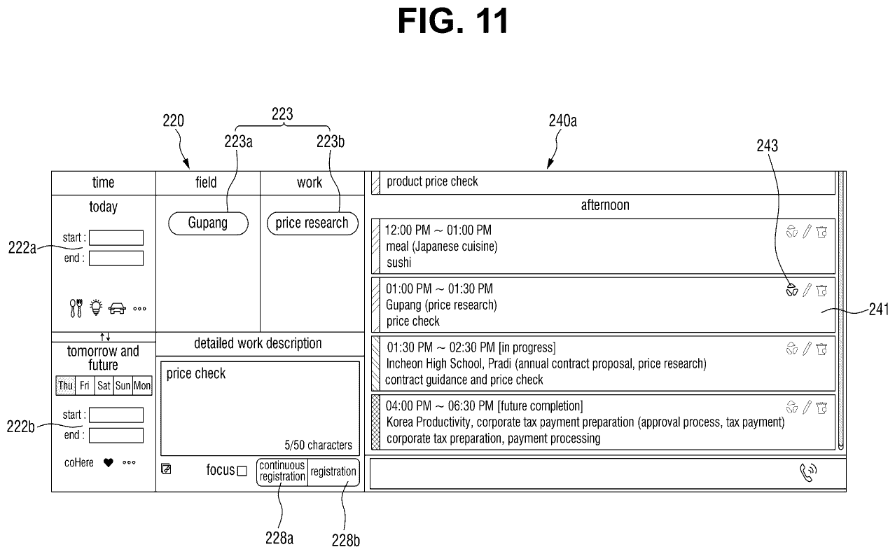

FIG. 9 is a flowchart illustrating the method for inputting schedules using the reuse button according to an embodiment of the present disclosure, and FIGS. 10 and 11 are exemplary diagrams illustrating the method for adding schedules using the reuse button of a schedule item in the schedule display table according to an embodiment of the present disclosure.

Referring to FIG. 9 and FIG. 10, in step S30, one or more schedule items including time information and other schedule details may be displayed in the user interface of the calendar application. In the following, the case where the schedule item is a schedule item 241 in the schedule display table 240 will be explained as an example, but the schedule item may also be a schedule box 231a or 231b in the timeline 230.

According to an embodiment of the present disclosure, as shown in FIG. 10, one or more schedule items 241 may be displayed in the schedule display table 240, and each schedule item 241 may include time information such as the start and end times 241a of the schedule, as well as other schedule details such as category information 241b, 241c, and information about the detailed description of the schedule 241d.

Additionally, each schedule item 241 may include an identifier 241e (e.g., a label, flag, etc.) of a different color in the left area of the schedule item, depending on whether the schedule item is a completed schedule, a planned schedule, or a schedule currently in progress at the current time.

Additionally, each schedule item 241 may include a reuse button 243, an edit button 244, and a delete button 245 in the area of the item, and these buttons may be displayed, for example, at the upper-right corner of the schedule item 241, although their position is not limited to this. Additionally, these reuse button 243, edit button 244, and delete button 245 may be displayed on the schedule item at all times, or they may be displayed when the user hovers the mouse or touches the item, or may appear in the form of a popup window. The specific method of display is not limited. Alternatively, instead of each schedule item 241 including the reuse button 243, edit button 244, and delete button 245, these buttons may be displayed adjacent to the schedule display table 240, with only one of each button displayed. The user may then select one of the reuse button 243, edit button 244, and delete button 245 after selecting a specific schedule item to perform the same function.

The reuse button 243 is displayed as an icon representing reusing, the edit button 244 is displayed as a pen-shaped icon, and the delete button 245 is displayed as a trash can-shaped icon. However, the specific form of display is not limited.

Referring to FIG. 9 and FIG. 11, in step S31, the user's selection of the reuse button included in or associated with a specific schedule item among one or more schedule items may be received through the user interface of the calendar application. For example, as shown in FIG. 11, when the user selects the reuse button 243 of a specific schedule item 241 in the first schedule display table 240a, the selected reuse button 243 may be highlighted.

In step S32, in response to receiving the user's selection of the reuse button, other schedule information corresponding to the schedule item to which the user selected reuse button belongs or the schedule item associated with the user selected reuse button may be filled in the input panel of the user interface of the calendar application. At this time, the other schedule information being filled may exclude the time information of the schedule item.

As a non-limiting example, referring to FIG. 11, other schedule information such as category information and detailed work description corresponding to the schedule item 241 in the first schedule display table 240a, to which the user selected reuse button 243 belongs, may be filled in the input panel 220, with the time information left blank and not entered.

As mentioned above, the input panel 220 includes the first item display section 223a and the second item display section 223b. In response to receiving the selection of the reuse button 243, at least one item button from the first associated category (e.g., the third category) corresponding to the schedule item 241 to which the user selected reuse button 243 belongs may be filled in the first item display section 223a, and at least one item button from the second associated category (e.g., the fourth category) corresponding to the schedule item 241 may be filled in the second item display section 223b. At this time, the second associated category (e.g., the fourth category) may be a lower category of the first associated category (e.g., the third category). In the example of FIG. 11, the first item display section 223a may have the “Gupang” item button, which corresponds to information from the third category in the schedule item 241, added. The second item display section 223b may have the “Price Research” item button, which corresponds to information from the fourth category in the schedule item 241, added. The detailed description input section 225 may have the entry “Price Check,” which corresponds to the detailed work description in the schedule item 241, filled in.

In addition, if there is an attachment linked to the schedule item 241, information about the attachment is associated with the link creation button 226, and if the schedule is for a meeting, information about other users attending the meeting may be associated with the person icon 226c (refer to FIG. 6a), and the information may be filled (added) in the input panel 220.

In step S33, time input for the other schedule information filled in the input panel 220 may be received from the user, and for example, by selecting the register button 228b, in step S34, a new schedule item corresponding to the other schedule information filled in the input panel 220 (e.g., category information, detailed work description, attachment, information about meeting participants, etc.) and the user's time input may be created. The newly created schedule item may be added to at least one of the schedule display table 240 or the timeline 230 within the user interface of the calendar application.

It should be noted that, in the example of FIG. 11 used in step S32, information corresponding to the third category and the fourth category for the schedule is filled and displayed in the first item display section 223a and the second item display section 223b of the input panel 220, respectively. However, in practice, the schedule may be associated with one or more upper categories for the displayed categories, i.e., the first category and the second category, and may be associated with a total of four categories. Information that is not limited to what is displayed in the input panel 220 may be associated with the newly created schedule information.

As described above, the method for inputting schedules using the reuse button according to an embodiment of the present disclosure may be used when a user wants to add a schedule by keeping at least one information among the information about the category of the schedule item 241 to which the reuse button 243 belongs, the detailed work description, attachment, or meeting participants, and only changing the time. From the user's perspective, in the actual work process, there are many cases where a user repeats a previously performed schedule or carries out a similar schedule. According to an embodiment of the present disclosure, by utilizing the information of a previously performed schedule as is, a new schedule may be easily registered. This approach significantly reduces the time and effort required for the user to input schedules, resulting in the effect of improving efficiency.

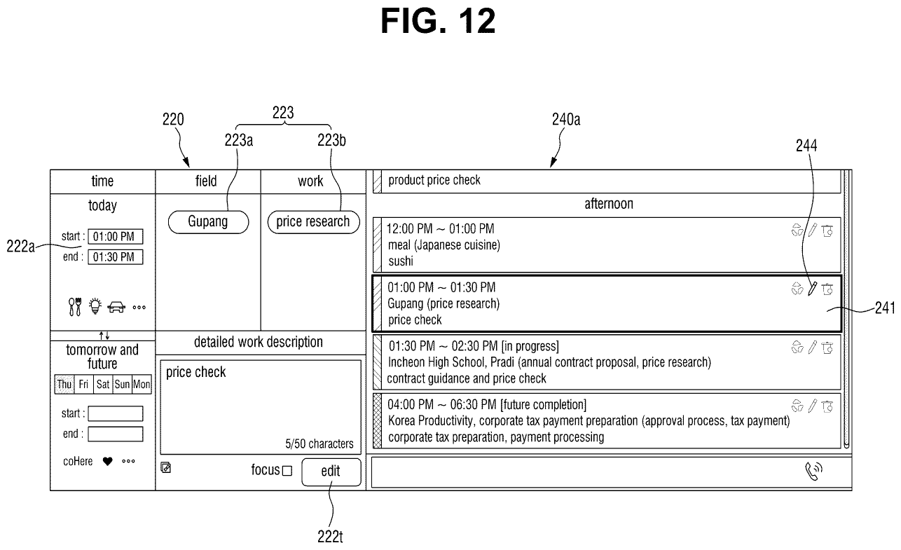

FIG. 12 is an exemplary diagram illustrating a method for adding a schedule using an edit button of the schedule items according to an embodiment of the present disclosure.

Referring to FIG. 12, the edit button 244 may be used when the user wants to modify at least one of the category, time, detailed schedule description of the schedule item 241 to which the edit button 244 belongs. When the edit button 244 is selected, the time information and other schedule information (e.g., category information and detailed schedule information) of the schedule item 241 to which the edit button 244 belongs are automatically filled in the item display section 223 and/or the detailed schedule display section 225 of the schedule panel 220. The user may then modify some of the desired information and simply complete the editing of the schedule item by pressing the edit button 222t.

It should be noted that, compared to the modification of the selected schedule (i.e., an existing schedule item) through the edit button 244, the method of reusing schedule information through the aforementioned reuse button 243 is related to generating a new schedule (i.e., a schedule item or schedule box) by reusing the schedule information of the existing schedule.

On the other hand, although the example in FIG. 12 describes the user modifying the schedule item 241 using the edit button 244, according to another example, when the user selects a specific schedule item 241 (e.g., by mouse click or touch), the time information and other schedule information for the selected schedule item 241 are automatically filled in the item display section 223 and/or the detailed schedule display section 225 of the schedule panel 220. The user can then modify some of the desired information and simply complete the editing of the schedule item by pressing the edit button 222t.

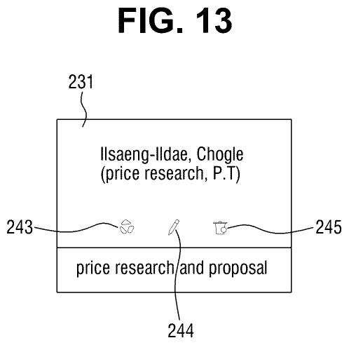

FIG. 13 is an exemplary diagram illustrating a method for adding a schedule using the reuse button of a schedule box in the timeline according to another embodiment of the present disclosure. Referring to FIG. 13, according to another embodiment of the present disclosure, instead of the schedule display table 240 in the user interface of the calendar application, the schedule item in the timeline 230, i.e., the schedule box 231, may include at least one of the reuse button (i.e., reuse button) 243, edit button 244, and delete button 245. When these buttons are implemented in the schedule box 231a of the timeline 230, considering that the display space is limited, when the user selects (e.g., mouse hovering, touch, etc.) the schedule box 231a, the reuse button and other buttons may be displayed in the area of the schedule box 231a, or these buttons may be displayed in the form of a popup window. The method for inputting schedules through the buttons 243, 244, and 245 according to the example in FIG. 13 is the same as the previously described method, so redundant explanations are omitted.

On the other hand, referring to FIG. 2, the goal display section 239 may display the progress of one or more schedules that the user is currently working on or plans to work on in a graphical format. When the user selects a specific schedule displayed in the goal display section 239, the category and/or detailed work description of that schedule, which the user has previously entered, may be automatically filled in the input panel 220, enabling it to perform a function similar to the reuse button 243.

In this way, by displaying the reuse button 243, edit button 244, and delete button 245 on each schedule item 241 in the schedule display table 240 (or on each schedule box 231 in the timeline 230), and using these buttons to promptly and easily register a schedule item with the same schedule information as an existing schedule, as well as enabling the user to promptly and easily edit and delete each schedule item, the user of the calendar application may easily and systematically understand and manage their schedule. Furthermore, such systematic and convenient schedule management may ultimately improve the user's work efficiency and serve as a motivation for the user to actively utilize schedule management through the calendar application.

### Computer-Readable Recording Medium

The fact that each step or operation of the method according to the embodiments of the present disclosure may be performed by a computer including one or more processors by executing a computer program stored in a computer-readable recording medium is apparent.

The computer-executable instructions stored in the aforementioned recording medium may be implemented through a computer program programmed to perform the corresponding steps, and such a computer program may be stored in a computer-readable recording medium and executed by a processor. The computer-readable recording medium may be a non-transitory readable medium. At this time, the non-transitory readable medium refers to a medium that does not store data for a brief moment, such as registers, cache, or memory, but rather stores data in a semi-permanent manner and is readable by a device. Specifically, programs for performing the various methods described above may be stored in and provided via non-transitory readable media, such as semiconductor memory devices including erasable programmable read-only memory (EPROM), electrically erasable programmable read-only memory (EEPROM), and flash memory devices; magnetic disks such as internal hard disks and removable disks; magneto-optical disks; and non-volatile memory including CD-ROM and DVD-ROM disks.

The methods according to various examples disclosed in this document may be provided as part of a computer program product. The computer program product may be distributed in the form of a machine-readable storage medium (e.g., compact disc read-only memory (CD-ROM)) or may be distributed online through an application store (e.g., Play Store™). In the case of online distribution, at least a portion of the computer program product may be at least temporarily stored in a storage medium such as the memory of a manufacturer's server, an application store server, or an intermediary server, or may be temporarily generated.

As described above, those skilled in the art to which the present disclosure pertains will understand that the present disclosure may be embodied in various specific forms without departing from the technical spirit or essential characteristics thereof. Therefore, the above-described embodiments should be understood as illustrative in all respects and not as limiting. The scope of the present disclosure is defined by the claims set forth below rather than by the detailed description, and all modifications or variations derived from the meaning, scope, and equivalent concepts of the claims should be interpreted as being included within the scope of the present disclosure.

The features and advantages described herein do not encompass all possible features and advantages, and in particular, numerous additional features and advantages will become apparent to those skilled in the art upon consideration of the drawings, the specification, and the claims. Furthermore, it should be noted that the language used in the present specification has been primarily selected for readability and instructional purposes and may not have been chosen to describe or limit the subject matter of the present disclosure.

The foregoing description of the embodiments of the present disclosure has been provided for illustrative purposes. This is not intended to limit the present disclosure to the exact form disclosed or to be made without omission. Those skilled in the art will appreciate that numerous modifications and variations are possible in light of the above disclosure.

Accordingly, the scope of the present disclosure is not limited by the detailed description but is defined by any claims of the application based thereon. Thus, the disclosure of the embodiments of the present disclosure is exemplary and does not limit the scope of the present disclosure as set forth in the following claims.

1. A method for reusing schedule information, comprising:
displaying one or more schedule items including time information and other schedule information for a schedule in the user interface of an application, wherein the user interface includes a reuse button associated with each of the schedule items;
receiving a selection of the reuse button associated with a schedule item among the one or more schedule items; and
in response to the receiving the selection of the reuse button, filling other schedule information corresponding to the schedule item associated with the reuse button in an input panel of the user interface;
wherein the input panel includes a first item display section; and
in response to the receiving the selection of the reuse button, the filling other schedule information corresponding to the schedule item associated with the reuse button in the input panel of the user interface includes:
in response to the receiving the selection of the reuse button, filling at least one item button of the first associated category corresponding to the schedule item in the first item display section.

2. The method for reusing schedule information according to claim 1, further comprising:
receiving time input for the other schedule information filled in the input panel; and
creating a new schedule item corresponding to the other schedule information and the time input.

3. The method for reusing schedule information according to claim 1, wherein the other schedule information includes category information for two or more categories of the schedule.

4. The method for reusing schedule information according to claim 3, wherein the other schedule information further includes at least one of information about another user associated with the schedule and the attachments associated with the schedule.

5. The method for reusing schedule information according to claim 1, wherein the one or more schedule items are displayed in a schedule display table displayed on the user interface.

6. The method for reusing schedule information according to claim 1, wherein the one or more schedule items are displayed in a timeline displayed on the user interface.

7. The method for reusing schedule information according to claim 1, wherein:
the user interface further includes an edit button in addition to the reuse button, and
the method further comprises:
receiving a selection of the edit button associated with a schedule item among the one or more schedule items; and
in response to the receiving the selection of the edit button, filling time information and other schedule information corresponding to the schedule item in the input panel of the user interface.

8. The method for reusing schedule information according to claim 1, wherein the method further comprises:
receiving a selection of a schedule item among the one or more schedule items; and
in response to the receiving the selection of the schedule item, filling time information and other schedule information corresponding to the schedule item in the input panel of the user interface.

9. The method for reusing schedule information according to claim 1, wherein:
the input panel further includes a second item display section, and
in response to the receiving the selection of the reuse button, the filling other schedule information corresponding to the schedule item associated with the reuse button in the input panel of the user interface further includes:
in response to the receiving the selection of the reuse button, filling at least one item button of the second associated category corresponding to the schedule item, wherein the second associated category is a category associated with the first associated category, into the second item display section.

10. The method for reusing schedule information according to claim 1, further comprising:
receiving time input for the other schedule information filled in the input panel; and
creating a new schedule item corresponding to the other schedule information and the time input,
wherein the newly created schedule item is further associated with one or more upper categories for the first associated category.

11. An apparatus for executing an application for implementing a method for reusing schedule information, the apparatus comprising:
a processor; and
a memory including computer-executable instructions,
wherein the computer-executable instructions, when executed by the processor, cause the processor to perform operations including:
displaying one or more schedule items, including time information and other schedule information for a schedule, in a user interface of the application, wherein the user interface includes a reuse button associated with each schedule item;
receiving a selection of the reuse button associated with a schedule item among the one or more schedule items; and
in response to the receiving the selection of the reuse button, filling other schedule information corresponding to the schedule item associated with the reuse button in the input panel of the user interface, and wherein the input panel includes a first item display section; and
in response to the receiving the selection of the reuse button, the filling the other schedule information corresponding to the schedule item associated with the reuse button in the input panel of the user interface includes:
in response to the receiving the selection of the reuse button, filling at least one item button of the first associated category corresponding to the schedule item in the first item display section.

12. A computer-readable recording medium storing computer-executable instructions,
wherein the computer-executable instructions, when executed by a processor, cause the processor to perform operations including:
displaying one or more schedule items, including time information and other schedule information for a schedule, in a user interface of the application, wherein the user interface includes a reuse button associated with each schedule item;
receiving a selection of the reuse button associated with a schedule item among the one or more schedule items; and
in response to the receiving the selection of the reuse button, filling other schedule information corresponding to the schedule item associated with the reuse button in an input panel of the user interface, and
wherein the input panel includes a first item display section; and
in response to the receiving the selection of the reuse button, the operation of the filling other schedule information corresponding to the schedule item associated with the reuse button in the input panel of the user interface further includes:
in response to the receiving the selection of the reuse button, filling at least one item button of the first associated category corresponding to the schedule item in the first item display section.
